(19) United States
(12) Patent Application Publication
(10) Pub. No.: US 2016/0092576 A1
(43) Pub. Date: Mar. 31, 2016

(54) ASSOCIATION- AND PERSPECTIVE-BASED CONTENT ITEM RECOMMENDATIONS

(71) Applicant: Yahoo!, Inc., Sunnyvale, CA (US)

(72) Inventors: Daniele Quercia, Barcelona (ES); Mounia Lalmas, London (GB); Eduardo Graells, Barcelona (ES)

(21) Appl. No.: 14/497,760

(22) Filed: Sep. 26, 2014

(51) Int. Cl. G06F 17/30

(52) U.S. Cl. CPC G06F 17/30867; G06F 17/30598; G06F 17/3053; G06F 17/30554

(57) ABSTRACT

Many content systems (e.g., social networks) present to a user a set of content items posted by other individuals. The user may selectively view content items that reinforce and are consistent with the user's perspective, creating an “echo chamber” effect. Conversely, content systems that selectively expose users to content items exhibiting contrary perspectives, and from individuals with no connection with the user, may alienate the user. Presented herein are techniques for recommending content items that present a different perspective from that of the user, and from individuals who share a similar profile to the user (e.g., alternative opinions from other individuals within the user's social circle or community). Optionally, opinions may be selected that do not directly oppose the user's perspective, but that are orthogonal with it. Such selective recommendations may persuade the user to consider contrary viewpoints that may alter the user's perspective while reducing user alienation.

### BACKGROUND

Within the field of computing, many scenarios involve a content system that presents, to one or more users, content items authored by other users, such as stories and opinions written by contacts in the user's social network, and comments provided in a comment network. The user may browse an index of content items, such as the headlines of a set of news articles or the titles of user opinions, and may selectively choose to view only the content items that are of particular interest to the user. Some content systems may simply present the entire set of recent content items to the user, while other content systems may proactively recommend content items that may be of interest to the user. Such predicted interest may be based, e.g., upon other content items that the user has chosen to view, and/or upon the contents of the user profile of the user.

### SUMMARY

While the recommendation of content items may generally facilitate the user's engagement with content items that are of predictable interest to the user, such recommendations may disproportionately select content items that are consistent with the user's perspectives. As a first such example, for many users, content items that are similar to the user's perspectives may be of predictably higher interest than content items that conflict with such perspectives, and a predictive model may disproportionately select such content items for presentation to the user. As a second such example, if content items are selected for recommendation that are similar to previously viewed content items by the same user, and if the user preferentially views content items that are consistent with the user's perspectives, then the user is not exposed to alternative perspectives. Such scenarios may create an “echo chamber” effect, where the user is not exposed to, familiar with, or even aware of alternative perspectives, or even of the existing diversity of perspectives.

Other techniques for presenting content items to the user may be designed that may reduce the “echo chamber” effect. For example, content items may be selected for recommendation that present perspectives opposing those of the user. However, the user may tend to disregard such recommendations based on the background of the individuals posting such opposing perspectives. As a first example, a user with a first cultural background may be presented a recommendation of a content item that was created and/or recommended by an individual of a second cultural background, but the user may dismiss the content item as not relevant or interesting to any individuals with the first cultural background. A content system that preferentially presents such recommendations may therefore alienate the user by presenting content items that the user deems to be irrelevant to the user's cultural background and interests. As a second example, a content system that recommends content items exhibiting perspectives that directly oppose the user's perspectives may be readily dismissed by the user.

Presented herein are techniques for presenting content items to a user that may alter the user's perspectives while reducing the alienation of the user. In accordance with such techniques, a content system may identify associates of the user who have user profiles that are similar to the user, such as individuals within the user's community or social network; individuals whose interests are similar to those of the user; and individuals who have shared experiences that are similar to those of the user. The content system may identify content items of such associates that is different from the user perspective of the user, and may recommend such content items to the user. For example, a recommendation for a food type that the user may not typically find appealing may be of greater interest to the user if the source of the recommendation is a contact within the user's social network than if the source is an individual of a different cultural background. Additionally, the content system may also preferentially recommend content items that do not directly oppose the user perspective of the user, but that are orthogonal with the user perspective. For example, if the user finds a particular food type to be unpalatable (e.g., if the user does not like coffee), the content system may not recommend content items that exhort the palatability of the food type (such as coffee recipes or recommendations of nearby cafés), but, rather, content items that exhort other beneficial effects of the food type (e.g., the health benefits of drinking coffee regularly, and/or the socioeconomic promotion of local coffee farmers). By selectively recommending to the user content items that differ from the user perspective and that are from associates with a similar user profile in accordance with the techniques presented herein, a content system may persuade the user to consider alternative perspectives, expand the user's exposure to a range of perspectives, and reduce the “echo chamber” effect.

### DESCRIPTION OF THE DRAWINGS

While the techniques presented herein may be embodied in alternative forms, the particular embodiments shown in the drawings are only a few such examples that are supplemental of the description provided herein. These embodiments are not to be interpreted as limiting any aspect of the invention, which is defined by the claims appended hereto.

FIG. 1 is an illustration of a scenario involving various examples of networks that may connect servers and clients.

FIG. 2 is an illustration of a scenario involving an example configuration of a server that may utilize at least a portion of the techniques presented herein.

FIG. 3 is an illustration of a scenario involving an example configuration of a client that may utilize at least a portion of the techniques presented herein.

FIG. 4 is an illustration of a scenario involving a content delivery network (CDN) that may be utilized in conjunction with the techniques presented herein.

FIG. 5 is an illustration of a scenario involving a content provider that presents content item recommendations to a user.

FIG. 6 is an illustration of a scenario featuring a content provider that presents content item recommendations to a user in accordance with the techniques presented herein.

FIG. 7 is an illustration of a scenario featuring an example method of presenting recommendations of content items to a user in accordance with the techniques presented herein.

FIG. 8 is an illustration of a scenario featuring an example server that presents recommendations of content items to a user in accordance with the techniques presented herein.

FIG. 9 is an illustration of a scenario featuring an example nontransitory memory device that causes a device to present recommendations of content items to a user in accordance with the techniques presented herein.

FIG. 10 is an illustration of a scenario featuring a clustering of individuals in order to infer the user perspectives of a user in accordance with the techniques presented herein.

FIG. 11 is an illustration of a scenario featuring a selection of user perspectives of a user in order to present recommendations of content items to the user in accordance with the techniques presented herein.

FIG. 12 is an illustration of a scenario featuring a ranking of content items according to content item ratings in accordance with the techniques presented herein.

FIG. 13 is an illustration of a scenario featuring a presentation of a layout of topics and associated word clouds for recommending and presenting content items to a user in accordance with the techniques presented herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and systems. Accordingly, this subject matter is not intended to be construed as limited to any example embodiments set forth herein; example embodiments are provided merely to be illustrative. Such embodiments may, for example, take the form of hardware, software, firmware or any combination thereof (other than software per se). A reasonably broad scope for claimed or covered subject matter is intended.

### 1. Computing Scenario

The following provides a discussion of some types of computing scenarios in which the disclosed subject matter may be utilized and/or implemented.

### 1.1. Networking

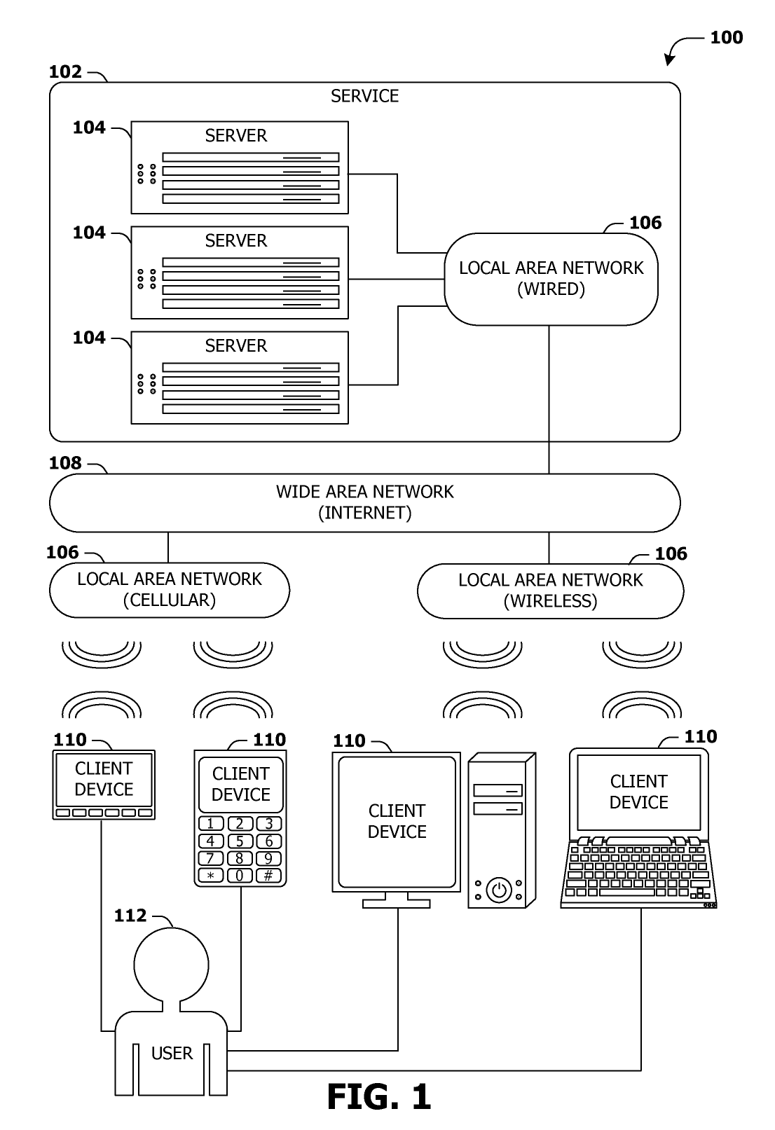

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may also be interconnected directly, or through one or more other networking devices, such as routers, switches, and repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may also include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and mesh architectures, and/or also a variety of roles, such as administrative servers, authentication servers, security monitor servers, data stores for objects such as files and databases, business logic servers, time synchronization servers, and front-end servers providing a user-facing interface to the service 102.

Likewise, the local area network 106 may comprise one or more sub-networks, such as may employ differing architectures or may be compliant or compatible with differing protocols, may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and client devices 110. The wide area network 108 may encompass various combinations of devices with varying levels of distribution and exposure, such as a public wide-area network (e.g., the Internet), or a private network (e.g., a virtual private network (VPN) of a distributed enterprise).

In the scenario 100 of FIG. 1, the service 102 may be accessed via the wide area network 108 by a user 112 of a set of client devices 110, such as a portable media player (e.g., an electronic text reader, an audio device, or a portable gaming, exercise, or navigation device); a portable communication device (e.g., a camera, a phone, or a text chatting device); a workstation; and a laptop form factor computer. The respective client devices 110 may communicate with the service 102 via various connections to the wide area network 108. As a first such example, one or more client devices 110 may comprise a cellular communicator, and may connect to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

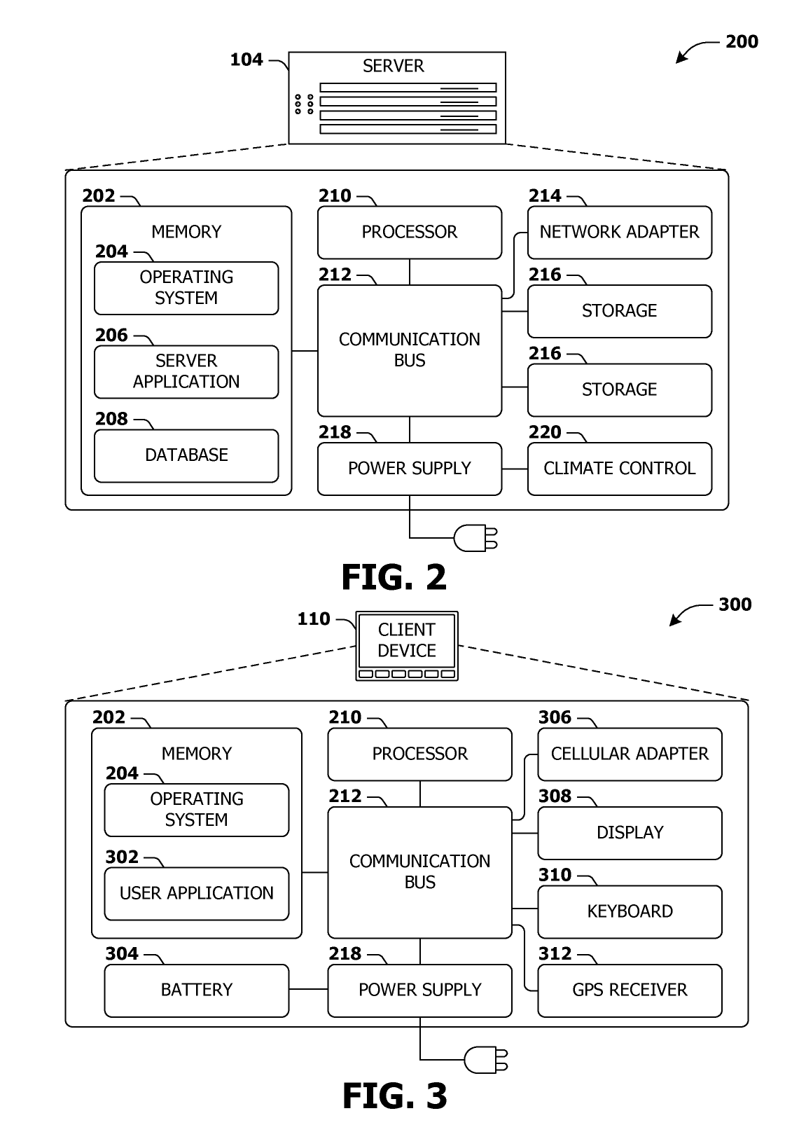

FIG. 2 presents a schematic architecture diagram 200 of a server 104 that may utilize at least a portion of the techniques provided herein. Such servers 104 may vary widely in configuration or capabilities, alone or in conjunction with other servers 104, in order to provide a service 102.

A server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. A server 104 may also comprise a memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may also comprise a variety of peripheral components, such as a wired and/or wireless network adapter 214 connectible to a local area network 106 and/or wide area network 108; one or more storage components 216, such as a hard disk drive, a solid-state storage device (SSD), a flash memory device, and/or a magnetic and/or optical disk reader. The server 104 may also comprise a mainboard featuring one or more communication buses 212 that interconnect the processor 210, the memory 202, and various peripherals, using a variety of bus technologies, such as a variant of a serial or parallel AT Attachment (ATA) bus protocol; the Uniform Serial Bus (USB) protocol; and the Small Computer System Interface (SCI) bus protocol. In a multibus scenario, a communication bus 212 may interconnect the server 104 with at least one other server 104. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

A server 104 may also operate in various physical enclosures, such as a desktop or tower, and/or may be integrated with a display as an “all-in-one” device. A server 104 may also be mounted horizontally and/or in a cabinet or rack, and/or may simply comprise an interconnected set of components. A server 104 may also comprise a dedicated and/or shared power supply 218 that supplies and regulates power for the other components. The server 104 may also provide power to and/or receive power from another server 104 and/or other devices. The server 104 may also comprise a shared and/or dedicated climate control unit 220 that regulates climate properties, such as temperature, humidity, and airflow. Many such servers 104 may be configured and/or adapted to utilize at least a portion of the techniques presented herein.

### 1.3. Client Device Configuration

FIG. 3 presents a schematic architecture diagram 300 of a client device 110 operable by a user 112, whereupon at least a portion of the techniques presented herein may be implemented. Such client devices 110 may vary widely in configuration or capabilities, in order to provide a variety of functionality to the user 112. A client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and a component of a piece of furniture, such as a tabletop, and/or of another device, such as a vehicle or residence. A client device 110 may also serve the user 112 in a variety of roles, such as a workstation, kiosk, media player, gaming device, and/or appliance.

A client device 110 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. A client device 110 may also comprise a memory 202 storing various forms of applications, such as an operating system 204; one or more user applications 302, such as document applications, media applications, file and data access applications, communication applications such as web browsers and email clients, utilities, and games; and drivers for various peripherals. A client device 110 may also comprise a variety of peripheral components, such as a wired and/or wireless network adapter 214 connectible to a local area network 106 and/or wide area network 108; one or more output components, such as a display 308 coupled with a display adapter (optionally including a graphical processing unit (GPU)), a sound adapter coupled with a speaker, and a printer; input devices for receiving input from the user 112, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, and/or an compass, accelerometer, and/or gyroscope that detects a physical orientation of the client device 110. Other components that may optionally be included with the client device 110 (though not shown in the schematic diagram 300 of FIG. 3) include one or more storage components 216, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

A client device 110 may comprise a mainboard featuring one or more communication buses 212 that interconnect the processor 210, the memory 202, and various peripherals, using a variety of bus technologies, such as a variant of a serial or parallel AT Attachment (ATA) bus protocol; the Uniform Serial Bus (USB) protocol; and the Small Computer System Interface (SCI) bus protocol. A client device 110 may also comprise a dedicated and/or shared power supply 218 that supplies and regulates power for the other components, and/or a battery 304 that stores power for use while the client device 110 is not connected to a power source via the power supply 218. The client device 110 may also provide power to and/or receive power from other client devices 110.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user 112 via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may also include one or more servers that may locally serve the client device 110 and/or other client devices 110 of the user 112 and other individuals. For example, a locally installed webserver may provide web content in response to locally submitted web requests. Many such client devices 110 may be configured and/or adapted to utilize at least a portion of the techniques presented herein.

### 1.4. Content Delivery Network

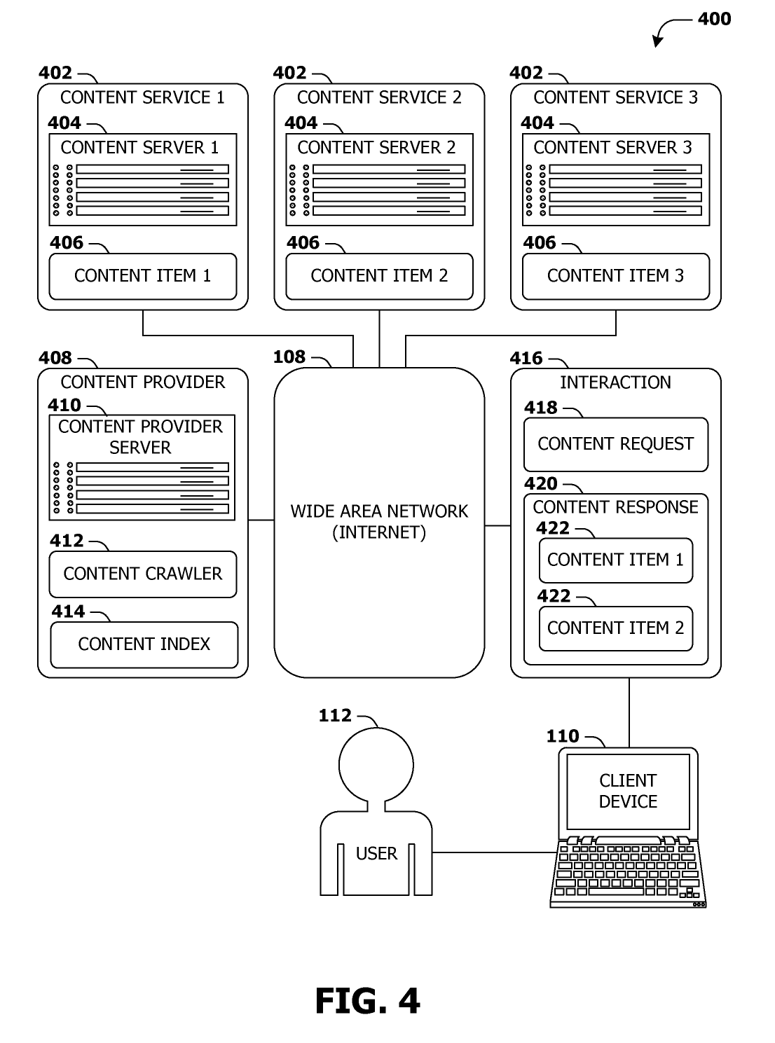

FIG. 4 is an interaction diagram of a scenario 400 featuring a content delivery network, also sometimes referred to as a content distribution network or CDN. These terms generally refer to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

In the scenario 400 of FIG. 4, a set of content services 402 respectively comprise a content server 404 that provides access to a set of content items 406, such as text articles, pictures, video, audio, applications, data files, and output from devices such as cameras. A content provider 408 is provided, comprising a content provider server 410 that interacts with the content services 402 over a wide area network 108, such as the Internet, to index the content items 406 provided thereby. For example, the content provider server 410 may utilize a content crawler 412 that iteratively explores the content services 402 and generates a content index 414. The content provider 408 may be deployed in a distributed manner across at least two content provider servers 410, which may be organized by role (e.g., a first content provider server 410 maintaining the content index 414, and a content provider server 410 interacting with users 112 and/or client devices 110) and/or geographically (e.g., various content provider servers 410 may be provided to service client devices 110 in different physical locations). Components may be duplicated within the content provider 408; e.g., two or more content provider servers 410 may be provided to facilitate the reliability, response time, and/or scalability of the content provider 408.

As further illustrated in the scenario 400 of FIG. 4, a user 112 of a client device 110 may engage in an interaction 416 with the content provider 408 and/or content services 402 in the following manner. For example, the client device 110 may present the content index 414 to the user 112, e.g., as a set of categories of topics that may be of interest to the user 112, such as articles about news stories, movies, music, or books. The user 112 may, through the client device 110, initiate a content request 418, such as a selection of a category from the content index 414. The content provider 408 may examine the content index 414 to select content items 406 responsive to the content request 418, and may generate a content response 420 including the selected content items 422 for presentation to the user 112. The content provider 408 may also utilize other techniques and/or components, such as an index storage component, a search component, a ranking component, a cache, a profile storage component, a logon component, a profile builder, and one or more application program interfaces (APIs). Many such content providers 408 may be provided, and may variously utilize the techniques presented herein.

In techniques such as those presented herein, content providers 408 may provide content stored by the same content provider 408 (e.g., a content provider 408 for a locally stored file system, database, or content library); for content stored by other content services 402; and/or for content stored by one or more client devices 110 (e.g., a cloud indexing service that indicates the availability of data objects on a distributed set of client devices 110 of the user 112). Additionally, such content providers 408 may provide a variety of content, including messages generated by and/or sent to the user 112; text articles; fiction and/or nonfiction stories; facts about topics such as individuals, companies, place; pictures; audio and video recordings; applications; data objects such as files and databases; and products or services.

Content providers 408 may receive and process content requests 418 specified in a variety of modalities, including text, handwriting, speech, verbal cues or keywords, gestures, and body language. The content requests 418 may also be specified in a variety of organizational formats, such as a group of keywords, a Boolean logical structure or expression tree, or a natural-language speech. Additionally, the content provider 408 may select content items 406 that are responsive to the content request 418 in various ways, such as a hyperlink to a uniform resource identifier (URI) of the content item 406; a description of the content item 406, such as the title, file type, generation date, synopsis, and/or preview version of the content item 406; and/or a copy of the full content item 406. The content response 420 may also be presented to the user 112 in many ways, such as in the same presentation as a search interface (e.g., presented in the same web page as the search interface, as in above, below, aside, or in place of the search interface); in a second presentation that is distinct from but related to the search interface (e.g., presented in a second web page or popup window); and/or in a second presentation that is unrelated to the search interface, such as a separate application (e.g., receiving a content request 418 through a web browser and presenting the content response 420 in a second application) and/or a different modality as the search interface (e.g., receiving a content request 418 provided in a web page, and presenting to the user 112 an audially presented set of content items 422).

### 1.5. Content Item Recommendations

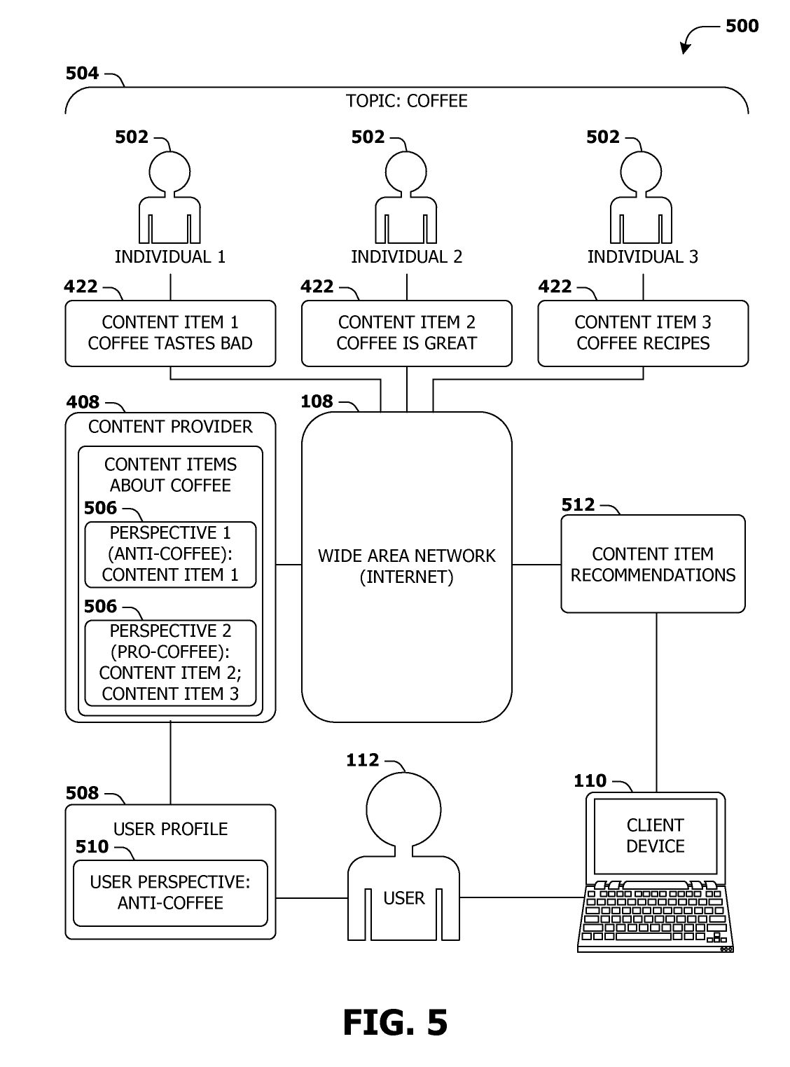

FIG. 5 presents a scenario 500 featuring a second example of a content provider 408 in a content delivery network, wherein the content provider 408 presents content item recommendations 512 of content items 422 to the user 112. In this scenario 500, a set of individuals 502 may be associated with content items 422 about a particular topic 504 (e.g., articles, messages, or options that the individual 502 has generated, authored, referenced, and/or approved). While some content providers 408 may present all discovered content items 422 to the user 112 in an equivalent manner, other content providers 408 may be configured to present to the user 112 content item recommendations 512 of content items 422 that are of predicted interest to the user 112. As a first such example, the content item recommendations 512 may be presented based on content item ratings by various individuals 502 (e.g., content items 512 that the entire body of individuals 502 have rated as most interesting). As a second such example, the content provider 408 may group the content items 422 according to an individual perspective 506 of the individual 502 about the topic 504; e.g., for a set of content items 422 about coffee, the content provider 408 may identify which content items 422 are associated with individuals 502 who exhibit a dislike of coffee and therefore express a negative perspective 506 about coffee, and which content items 402 are associated with individuals 502 who exhibit an appreciation of coffee and therefore express a positive perspective 506 about coffee. A user profile 508 of the user 112 may indicate a user perspective 510 of the user 112 about the topic 504 (e.g., that the user 112 exhibits a dislike of coffee), and the content provider 408 may compare the user perspective 510 of the user 112 with the individual perspectives 506 of the individuals 502 in order to select content items 422 as content item recommendations 512. The selected content items 422 may be transmitted to a client device 110 of the user 112 (e.g., as a web page featuring the content item recommendations 512 as a title, preview, or summary of each selected content item 422), which the user 112 may select in order to view the full content item 422.

While the technique illustrated in the exemplary scenario 500 of FIG. 5 may enable the presentation of content item recommendations 512 based on the user perspective 510 of the user 112, some disadvantages may arise from this technique.

As a first such example, a selection of content items 422 about a topic 504, from individuals 502 whose individual perspective 506 about the topic 504 match the user perspective 510 of the user 112, may result in a preferential exposure to the user 112 only of individual perspectives 506 that are consistent with the user perspective 510 of the user 112, and that limits or eliminates exposure of the user 112 to alternative individual perspectives 506 about the topic 504. Such altered exposure may create an “echo chamber” effect that disproportionately reinforces or strengthens the user perspective 510 of the user 112, wherein the user 112 does not understand, is not familiar with, and perhaps is not even aware of alternative individual perspectives 506 about the topic 504.

As a second such example, the restriction of content item recommendations 512 to the user 112 that preferentially selects individual perspectives 506 about a topic 504 that are consistent with the user perspectives 510 of the user 112 about the topic 504 may be interesting some users 112, but may not be interesting to more open-minded users 112 who appreciate a range of alternative individual perspectives 506 about various topics 504. For example, a user 112 may not actually seek or appreciate reinforcement of the user perspectives 510 currently held by the user 112 about a topic 504, but may seek exposure to new topics 504 and individual perspectives 506 that the user 112 has not previously considered. Accordingly, the presentation of content item recommendations 512 to such a user 112 may result in the presentation of content items 422 of diminished appeal to the user 112.

Conversely, the content provider 408 may present to the user 112 content item recommendations 512 for a topic 504 that feature content items 422 that present contrary individual perspectives 506 about the topic 504 to the user perspective 510 of the user 112 about the topic 504. However, such content item recommendations 512 may alienate users 112 who are not open to contrary individual perspectives 506. As a first such example, for a user 112 who expresses distaste for coffee, presenting a set of content items 422 that present an individual perspective 506 of appreciation for the taste of coffee may not be of interest to the user 112, since the user 112 may not be persuaded to change his or her views about the taste of coffee simply through exposure to contrary individual perspectives 506. As a second such example, if the content items 422 that are presented to the user 112 exhibit not only contrary individual perspectives 506 but also are associated with much different types of individuals 502 than the user 112 (e.g., as the opinions of individuals 502 from a much different age, culture, religion, political orientation, education level, and/or socioeconomic status than the user 112), the user 112 may be inclined to dismiss the contrary individual perspectives 506 outright, and/or to disregard the content item recommendations 512 as having no relevance to the user 112. As a third such example, a user 112 may feel strongly about a topic 504, such that the presentation of content items 42 exhibiting a directly opposite individual perspective 506 may prompt a negative response from the user 112 and an instinctive dismissal of the content item recommendations 512. For these and other reasons, differences between the user perspectives 510 of the user 112 individual perspectives 506 of the individuals 502 associated with the content item recommendations 512 may cause some users 112 to feel alienated by the content item recommendations 512 of the content provider 408.

### 2. Presented Techniques

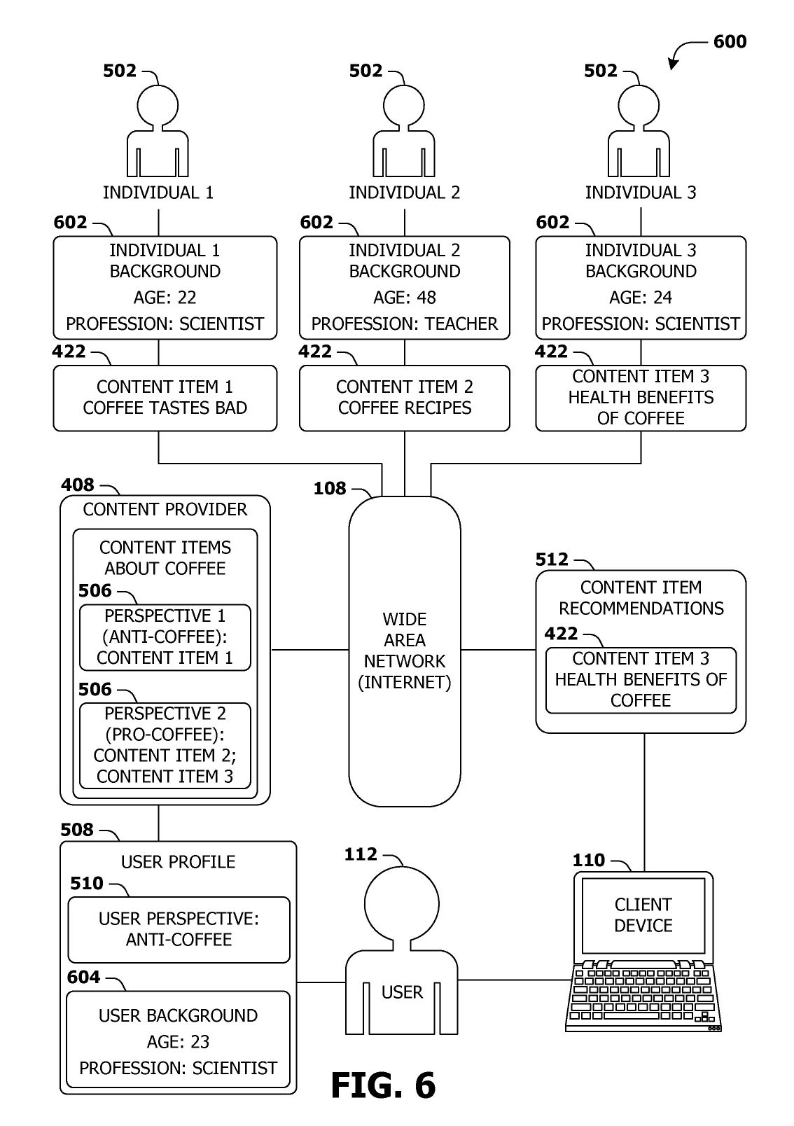

FIG. 6 is an illustration of a scenario 600 involving an alternative technique for presenting content item recommendations 512 to a user 112 in accordance with the techniques presented herein.

In this scenario 600, for a particular topic 504, a content provider 408 receives a set of content items 422 that are respectively associated with an individual 502 who exhibits an individual perspective 506 about the topic 504. The content provider 408 may therefore group the content items 422 according to the individual perspectives 506 about the topic 502, and may utilize such groupings in the selection of content items 422 as content item recommendations 512 to be transmitted to a client device 110 for presentation to a user 112.

However, the selection of content items 422 as content item recommendations 512 may also involve a comparison of an individual background 602 of each individual 502 with a user background 604 of the user 112 (e.g., according to user background 604 about the user 112 stored in a user profile 508). For example, the comparison may involve the ages of the individuals 502 and the user 112; the professions of the individuals 502 and the user 112; the geographic locations of the individuals 502 and the user 112; the education level and/or socioeconomic status of the individuals 502 and the user 112; the affiliation of the individuals 502 and the user 112 with various organizations; and the sets of skills, hobbies, and/or topical interests of the individuals 502 and the user 112. Among such individuals 502, a selection may be performed of individuals 502 whose individual backgrounds 602 are most similar to that of the user background 604 of the user 112. Then, among the selected individuals 502, an identification may be performed of content items 422 that involve an individual perspective 506 about the topic 504 of the content item 422 that differ from the user perspective 510 of the user 112. That is, the content provider 408 may identify content items 422 that were created, referenced, and/or approved by individuals 502 who have closely similar individual backgrounds 602 to the user background 604 of the user 112 (e.g., members of the same community or social network), and yet that express divergent individual perspectives 506 about a topic 604 than the user perspective 510 of the user 112 about the topic 604. Such content items 422 may be transmitted by the content provider 408 to the client device 110 for presentation to the user 112 as content item recommendations 512.

### 3. Technical Effect

The techniques presented herein and illustrated in the scenario 600 of FIG. 6 may provide a variety of technical effects for the client device 110 and/or the content provider server 410.

As a first technical effect, the identification and presentation of such content items 422 to the user 112 as content item recommendations 512 may be interesting, and possibly persuasive, to the user 112 for a variety of reasons. As a first such example, the user 112 may find interest in the fact that individuals 502 having very similar individual backgrounds 602 to the user background 604 of the user 112 hold divergent individual perspectives 506 about the topic 504 than the user perspective 510 of the user 112, and may be persuaded to reconsider individual perspectives 506 that the user 112 might have otherwise disregarded as irrelevant to the user 112. As a second such example, the user 112 may be interested in understanding the individual perspectives 506 about various topics 504 that are held by individuals 602 who are very similar to the user 112. For instance, a member of a social group, such as a member of an organization such as a student body of a university, may feel compelled to understand the tastes and opinions of other individuals 502 within the social group, e.g., in order to fit in with and/or respect the opinions of the social group, and/or to identify conversation topics with other individuals 502 within the social group. Accordingly, such selectivity may improve the engagement of users 112 with the content provider 408, e.g., by increasing the predicted interest and appeal of content item recommendations 512 that are presented to the user 112.

As a second technical effect, the identification of content item recommendations 512 in accordance with the techniques presented herein may improve the efficiency of the content provider 408 in presenting content items 422 to users 112. For example, users 112 are often inclined to scroll through a continuous set of content item recommendations 512 until finding a content item 422 that is of interest to the user 112, and may then select the content item 422 for viewing (e.g., “clicking through” from the content provider 408 to the content service 402 that hosts the content item 406). In such scenarios, each content item 406 that is presented to the user 112, but that the user 112 skips over and does not select for viewing, represents a waste of resources on the part of the content provider 408 in selecting and transmitting the content item 406 to the user 112. That is, presenting ten content item recommendations 406 to the user 112 that result in two “click-through” responses from the user 112 is more efficient than presenting fifty content item recommendations 406 that result in the same two “click-through” responses from the user 112. In addition to promoting user engagement of the user 112 with the content provider 408, such improvements in efficiency may conserve the resources of the content provider 408 in reducing the number of content item recommendations 512 that are not of interest to the user 112. Such efficiency improvements may also promote the scalability of the content provider 408 to serve a larger number of users 112.

As a third technical effect, the use of the techniques presented herein may facilitate the efficiency of the client device 110. For example, many client devices 110, such as mobile phones, feature only a small display 308, a limited-capacity network connection, and/or a limited-capacity battery 304. The use of the techniques presented herein to reduce the set of content item recommendations 512 to a smaller set that is of greater probable interest to the user 112 may reduce the inefficient consumption of the resources of the client device 110 in presenting other content item recommendations 512 that are not of interest to the user 112. These and other technical effects may be achievable through the selection of content item recommendations 512 in accordance with the techniques presented herein.

### 4. Example Embodiments

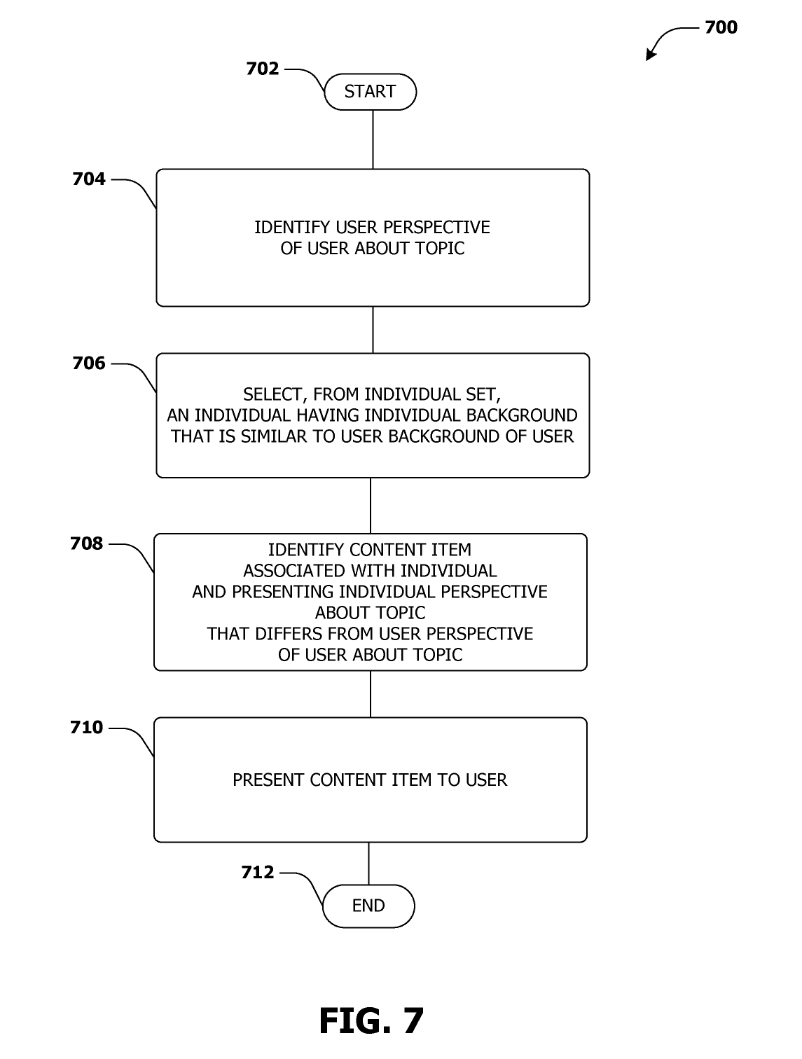

FIG. 7 presents an illustration of a first example embodiment of the techniques presented herein, illustrated as an example method 700 of presenting a content item recommendation 512 to a user 112 having a user background 604. The example method 700 may be implemented, e.g., as instructions stored in a memory (e.g., a hard disk drive, a solid-state storage device such as a flash memory device, or a magnetic or optical disc) that, when executed on a processor 210 of a computer such as a client device 112 and/or a server 104, cause the computer to operate according to at least a portion of the techniques presented herein. The example method 700 begins at 702 and comprises identifying 704 a user perspective 510 of the user 112 about a topic 504. The example method 700 further comprises selecting 706, from an individual set, an individual 502 having an individual background 602 that is similar to the user background 604 of the user 112. The example method 700 further comprises identifying 708 a content item 422 that is associated with the individual 502, and that presents an individual perspective 506 about the topic 504 that differs from the user perspective 510 of the user 112 about the topic 504. The example method 700 further comprises presenting 710 the content item 422 to the user 112. In this manner, the example method 700 achieves the presentation of the content item recommendation 512 to the user 112 in accordance with the techniques presented herein, and so ends at 712.

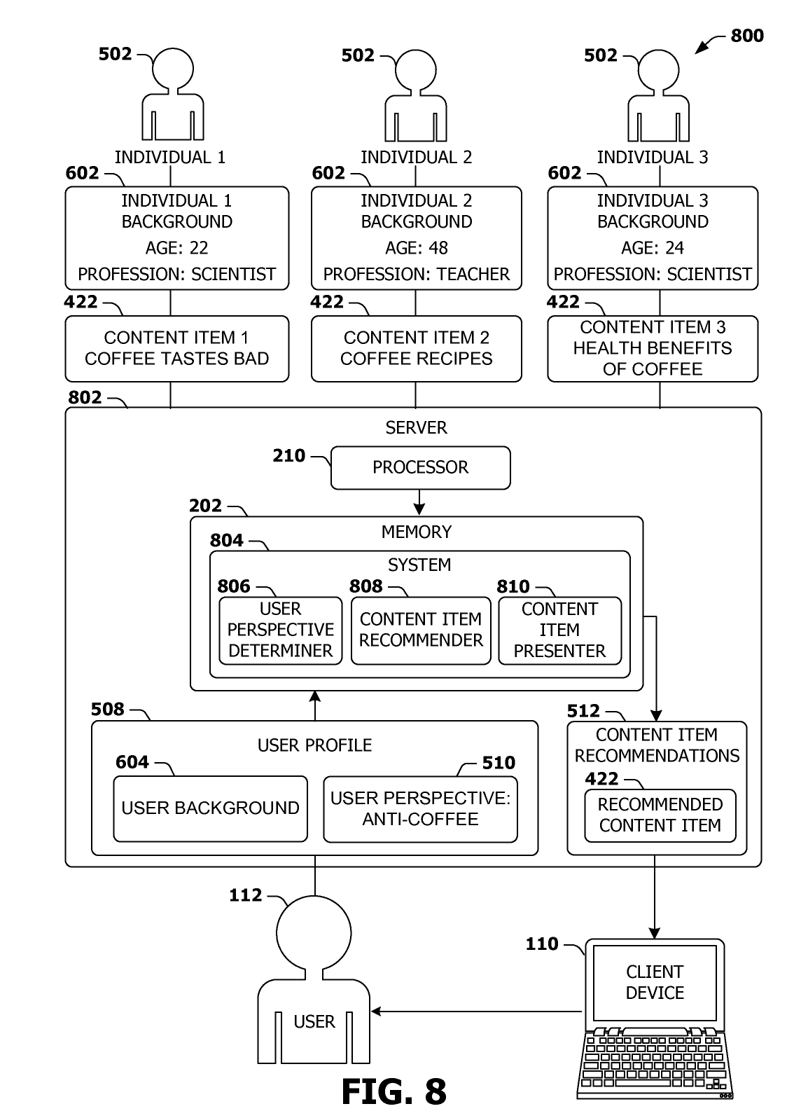

FIG. 8 presents an illustration of a scenario 800 involving a second example embodiment of the techniques presented herein, comprising a server 802 that presents a content item recommendation 512 of a content item 422 to a user 112. The server 802 may comprise a processor 210, and a memory (e.g., a hard disk drive, a solid-state storage device such as a flash memory device, or a magnetic or optical disc) storing a user profile 508 of the user 112 that includes a user background 604 (e.g., information about the user's demographics, skills, interests, and experiences), and instructions that provide the components of an example system 804 that causes the server 802 to present a content item recommendation 512 to a user 112. In particular, the example system 804 comprises a user perspective determiner 806 that identifies a user perspective 510 of the user 112 about a topic 504. The example system 804 also comprises a content item recommender 808 that selects, from an individual set, an individual 502 having an individual background 602 that is similar to the user background 604 of the user 112, and identifies a content item 422 that is associated with the individual 502 and that presents an individual perspective 506 about the topic 504 that differs from the user perspective 510 of the user 112 about the topic 504. The example system 804 also comprises a content item presenter 810 that presents the content item 422 to the user 112 (e.g., by transmitting the content item recommendations 512 to the client device 110 for presentation to the user 112). In this manner, the server 802 in the scenario 800 of FIG. 8 presents content item recommendations 512 to the user 112 in accordance with the techniques presented herein.

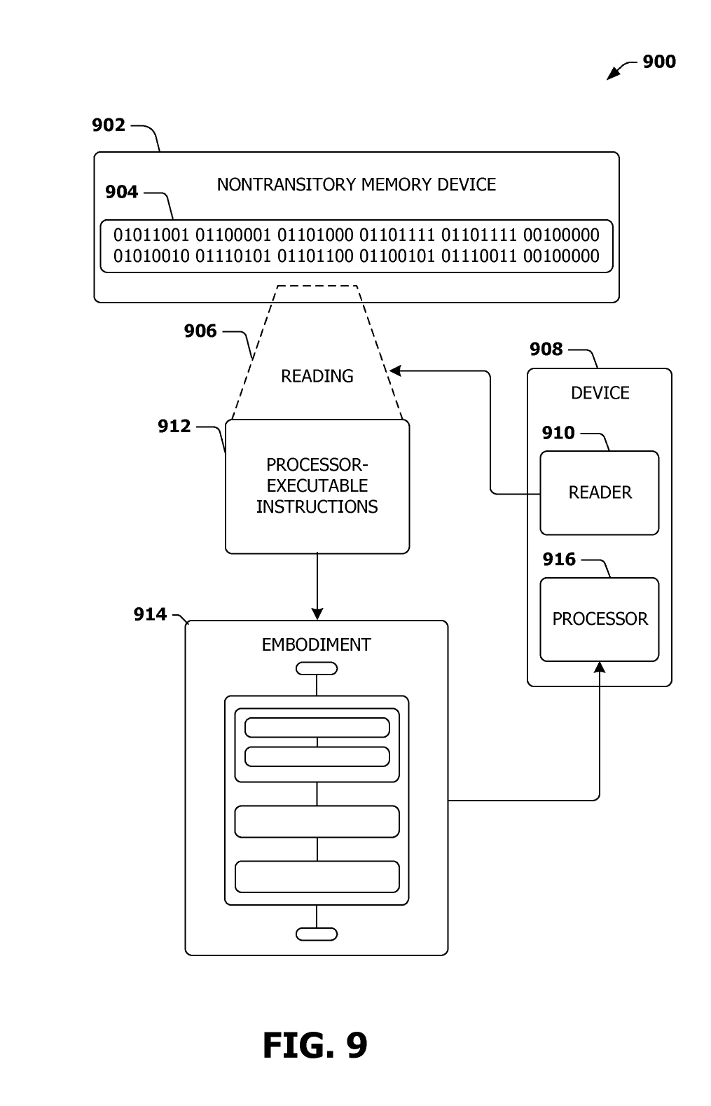

FIG. 9 is an illustration of a scenario 900 involving a third example embodiment of the techniques presented herein, comprising an example nontransitory memory device 902, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 902 stores computer-readable data 904 that, when subjected to reading 906 by a reader 901 of a device 908 (e.g., a read head of a hard disk drive, or a read operation invoked on a solid-state storage device), express processor-executable instructions 912. The processor-executable instructions 912, when executed on a processor 916 of the device 908, cause the device 908 to present a content item recommendation 512 to a user 112. In particular, the processor-executable instructions 912 cause the device 908 to identify 704 a user perspective 510 of the user 112 about a topic 504. The processor-executable instructions 912 also cause the device 908 to select, 706, from an individual set, an individual 502 having an individual background 602 that is similar to the user background 604 of the user 112. The processor-executable instructions 912 also cause the device 908 to identify 708 a content item 422 that is associated with the individual 502, and that presents an individual perspective 506 about the topic 504 that differs from the user perspective 510 of the user 112 about the topic 504. The processor-executable instructions 912 also cause the device 908 to present 710 the content item 422 to the user 112. In this manner, the example nontransitory memory device 902 causes the device 908 to present the content item recommendation 512 to the user 112 in accordance with the techniques presented herein.

### 5. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example method 700 of FIG. 7; the example system 804 of FIG. 8; and the example nontransitory memory device 902 of FIG. 9) to confer individual and/or synergistic advantages upon such embodiments.

### 5.1. Identifying User Perspectives

A first aspect that may vary among embodiments of the presented techniques involves the manner of identifying the user perspectives 510 of the user 112 about various topics 504.

As a first variation of this first aspect, the user perspectives 510 of the user 112 may be detected by explicit statements by and/or descriptors of the user 112. For example, the user 112 may specify one or more user perspectives 510 in a message, such as an email message, a chat message, or a post on a social network or a web forum.

As a second variation of this first aspect, the user perspectives 510 of the user 112 may be inferred from other information in the user background 604 of the user 112.

As a first example of this second variation of this first aspect, correlation of the demographics of various individuals 502 with individual perspectives 506 that are frequently held by individuals 502 with such demographics (e.g., age, culture, educational and/or professional history, income level, geographic location of residence, skills, experiences, and/or interests) may enable an inference of the user perspectives 510 of the user 112 based on the demographics of the user 112.

As a first example of this second variation of this first aspect, an identification of the individual perspectives 506 that are frequently held by a user set that includes the user 112 (e.g., the user's social network, or an organization with which the user 112 is affiliated, such as a business, school, or community) may enable an evaluation of the individual perspectives 506 of the individuals 502 comprising the user set, and thus an inference of the user perspectives 510 of the user 112. For example, respective messages that are expressed by the members of the user set may be evaluated to identify at least one identifier in the message (e.g., a name, term, phrase, URL, or hashtag that often arises in the messages expressed by individuals 502 having a particular user perspective 510), and the identifiers may be correlated with a user perspective 510 of the member about the topic.

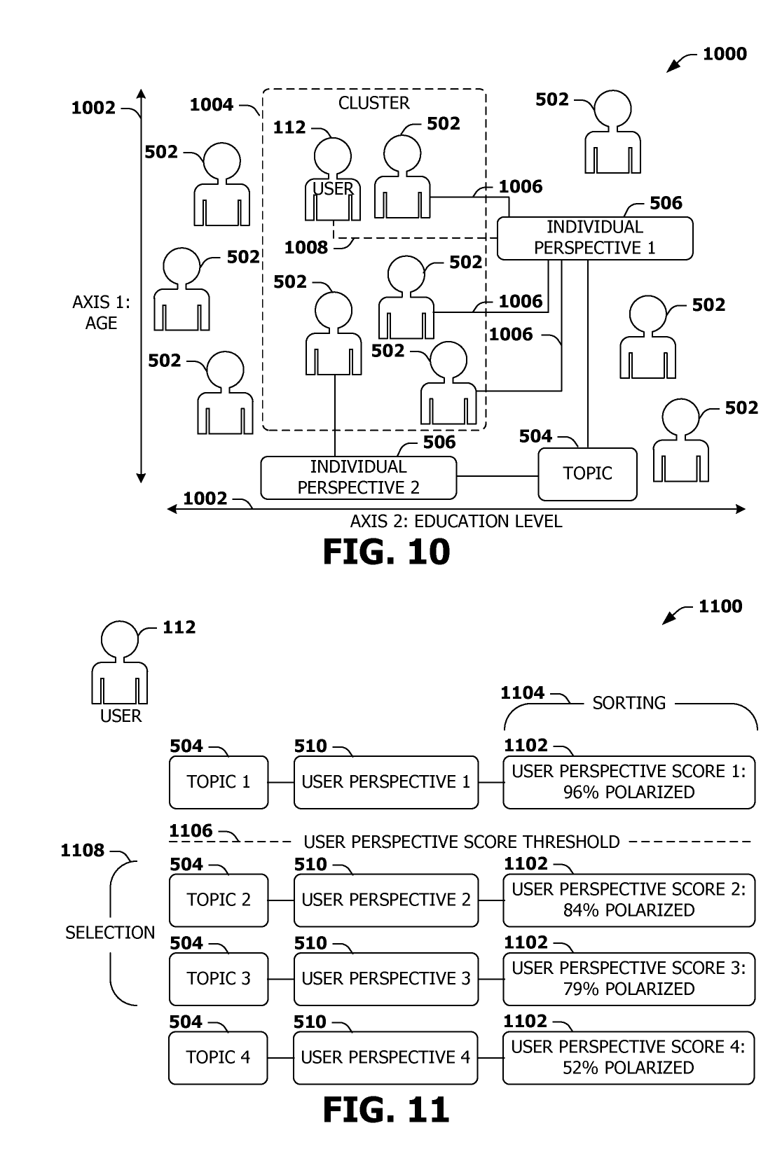

FIG. 10 is an illustration of a scenario 1000 featuring an application of this first example of this second variation of this first aspect. In this scenario 1000, individuals 502 are clustered according to various demographics, which are depicted as a first axis 1002 representing the ages of the individuals 502 and a second axis 1002 representing the educational levels of the individuals 502. Additional axes 1002 (not illustrated) may be utilized to map the individuals 1004 in higher dimensions, such as a third axis 1002 representing cultures, and a fourth axis 1002 representing income levels. A cluster 1004 of individuals 502 may be identified, comprising individuals 502 that share a proximity when mapped according to the axes 1002. A first individual perspective 506 about a topic 504 that is shared 1006 by many individuals 502 may be identified, and may be imputed to a user 112 that is also within the cluster 1004. Additionally, if a second user perspective 510 about the topic 504 is identified that differs from the first user perspective 501 is associated with and/or expressed by another individual 502 of the cluster 1004, the second user perspective 510 may be selected for presentation to the user 112.

As a third variation of this first aspect, among the user perspectives 510 of the user 112, particular user perspectives 510 may be selected as amenable to the presentation of differing individual perspectives 506 in accordance with the techniques presented herein. As a first such example, identifying the user perspective 510 of the user 112 may comprise, the respective topics 504 that are associated with a user perspective 510 of the user 112 may be ranked according to a user perspective score of the user perspective 510 about the topic 504, e.g., the level of interest and/or the strength of the opinion of the user 112 about the user perspective 510 and/or the topic 504. A representative user perspective subset of the user 112 may be selected according to the user perspective scores of the user perspectives 510 about the topic 504, about which differing individual perspectives 504 may be identified and presented to the user 112. As a first further variation, selecting the representative user perspective subset may involve excluding an excluded user perspective 510 that has a user perspective score about the topic 504 that is above a maximum user perspective score threshold (e.g., if the user 112 holds a particularly strong opinion and/or knowledge about a topic 504, presenting differing individual perspectives 504 may have a greater likelihood of alienating the user 112). As a second further variation, selecting the representative user perspective subset may involve excluding an excluded user perspective 510 that has a user perspective score about the topic 504 that is below a minimum user perspective score (e.g., if the user 112 is particularly uninterested in, uninformed about, and/or apathetic about a particular topic 504, presenting differing individual perspectives 504 from other individuals 502 may not be of significant interest to the user 112).

FIG. 11 presents an illustration of a scenario 1100 featuring one such technique for selecting 1108 a subset of user perspective 510 of a user 112. In this scenario 1100, the user perspectives 510 of the user 112 about various topics 504 may be assigned a user perspective score 1102 (e.g., a metric of the user's polarity, knowledge, and/or interest in a particular topic 504), which may be assessed, e.g., according to how often the user 112 refers to the topic 504 in conversation; the tone of expressions of the user 112 while discussing the topic 504 and/or the user perspective 510; and/or the user background 604 of the user 112. Sorting 1104 by user perspective scores 1102 may be applied to the user perspectives 510, and a maximum user perspective score threshold 1106 may be applied to remove a user perspective 510 about which the user 112 is so polarized that the presentation of differing individual perspectives 504 may be undesirable. A selection 1108 of the topic two user perspectives 510 among the remaining user perspectives 510 may enable an identification of the topics 504 about which differing individual perspectives 504 of other individuals 502 may be desirably identified and selected in accordance with the techniques presented herein.

### 5.2. Identifying Individuals and Content Items

A second aspect that may vary among embodiments of the presented techniques involves the manner of selecting individuals 502 based on a similarity of the background individual background 602 of the individual 502 to the user background 604 of the user 112, and choosing the content items 422 associated with a selected individual 502 for presentation to the user 112.

As a first variation of this second aspect, the individual 502 may be selected by comparing respective individual background details of the individual background 602 of the individual 502 to the user background 604 of the user 112 to determine the similarity of the individual background 602 and the user background 604. For example, a clustering technique, such as provided in the scenario 1000 of FIG. 10, may be utilized to determine a cluster 1004 of individuals 502 that are similar to the user 112. In some such variations, a similarity score may be generated that quantifies the similarity of the respective individuals 502 to the user 112, and the individuals 502 may be ranked according to the similarity score.

As a second variation of this second aspect, an individual 502 may be selected according to a network distance of the individual 502 and the user 112 within an individual set, such as the proximity of the user 112 and the individual 502 within a family tree, an organizational hierarchy, and/or a social network.

As a third variation of this second aspect, the individual perspectives 506 associated with various content items 422 of a selected individual 502 may be determined in various ways in the context of determining a degree of perspective difference between the user perspective 510 of the user 112 and the individual perspective 506 of the individuals 502 in order to select a content item 422 presenting a perspective difference. In a first such variation, a perspective score may be generated that quantifies the individual perspective 506 of the individual 502 and/or the content item 422. For example, an evaluation of various sources of discussion of a topic 504, such as a political issue, may enable the identification of keywords that are correlated with various individual perspectives 506 (e.g., individuals 502 discussing the topic 504 from a first individual perspective 506 may commonly use a first set of terms, while individuals 502 discussing the topic 504 from a second individual perspective 506 may commonly use a second set of terms). The frequencies of the terms used in a content item 422 may therefore enable a calculation of a perspective score indicating the strength and/or confidence of the correlation of the content item 422 and/or the individual 502 with a particular individual perspective 506. As a further such variation, a perspective difference score may be calculated between the individual perspective 506 of the individual 502 and/or the content item 42, and the user perspective 510 of the user 112; and among a set of content items 422, a particular content item 422 may be selected that has a perspective difference score within a perspective difference score range (e.g., at least 50% different from the user perspective 510 of the user 112, but less than 80% different from the user perspective 510 of the user 112, as presenting a content item 422 from a strongly conflicting individual perspective 506 on a highly polarized topic 504 may alienate the user 112).

As a fourth variation of this second aspect, the user 112 may be evaluated to determine the openness and/or interest of the user 112 in receiving recommendations of content items 422 exhibiting individual perspective 506 that present varying degrees of difference from the user perspective 510 of the user 112. For example, some users 112 may be receptive to highly differing individual perspectives 506, while others may be only interested in modest differences. Conversely, some users 112 may be interested in content items 422 that are modestly different from the user perspective 510 of the user 112 (e.g., those that add subtlety, nuance, or qualifications to the user perspective 510 of the user 112), while other users 112 may not be interested in content items 422 that exhibit individual perspectives 506 that are too similar to the user perspective 510 of the user 112 (e.g., users 112 who are eager to avoid the “echo chamber” effect). Accordingly, in one such variation, the user 112 is associated with a diversity score, and the perspective difference score between the individual perspective 506 of the respective content items 422 and the user perspective 510 of the user 112 about the topic 504 may be calculated, and compared with the diversity score in order to select content items 422 for recommendation to the user 112.

As a fifth variation of this second aspect, a content item 422 may be identified and selected that presents an individual perspective 506 that differs from the user perspective 510 of the user 112 about the topic 504, but that does not oppose the user perspective 510 of the user 112 about the topic 504. That is, on a particular topic 504, such as coffee, various content items 422 may be associated with individual perspectives 506 that are aligned across a variety of perspective axes, such as the taste of coffee (tastes good vs. tastes bad); the health consequences of drinking coffee (improves health vs. debilitates health); the social implications of drinking coffee (coffee is stylish vs. coffee is tacky); and the economic implications of drinking coffee (purchasing coffee is economically beneficial vs. purchasing coffee is economically damaging). If a user 112 has developed a strong user perspective 510 about a topic 504 along a first axis, the user 112 might not be interested in content items 422 exhibiting an individual perspective 506 that directly conflicts with the user perspective 510, but may be interested in content items 422 that exhibit an individual perspective 506 along a different axis that the user 112 has not previously considered.

As a sixth variation of this second aspect, a content item 422 may be identified and selected according to user ratings of the content item 422. For example, upon receiving, from a first user 112, at least one user rating of the content item 422, an embodiment may store the user rating of the content item 422, and may identify a content item 422 for presentation to a second user 112 according to the user ratings stored for the content item 422 (e.g., selecting a content item 422 that is not only associated with an individual 502 having a similar individual background 602 to the user background 604 of the user 112 and that presents an individual perspective 506 that differs from the user perspective 510 of the user 112, but that also is highly rated among a set of users 112). Such user ratings may reflect, e.g., the novelty of an individual perspective 506 that is expressed by the content item 422; the persuasiveness and/or coherence with which the content item 422 expresses the individual perspective 506 of a user 502; and/or the accuracy and/or precision with which a content item 422 expresses the individual perspective 506 of a particular individual 502.

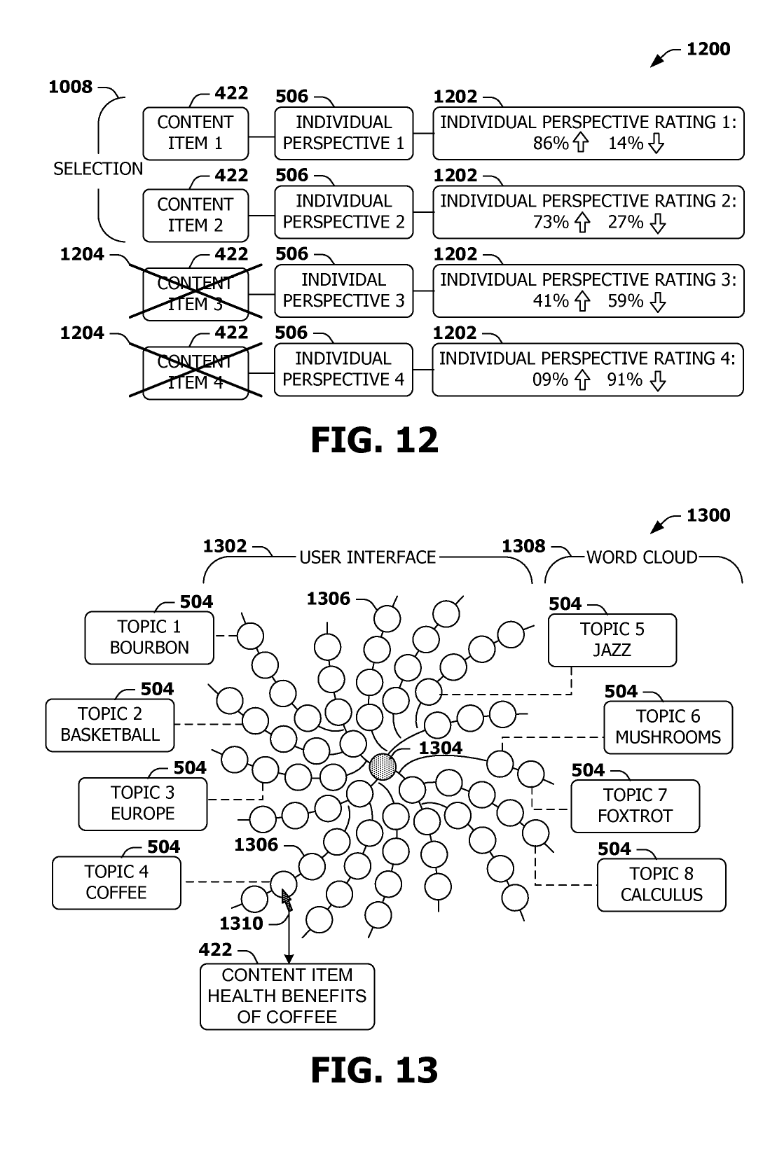

FIG. 12 presents an illustration of a scenario 1200 featuring the selection of content items 422 for topics 502 based on a user rating 1202. In this scenario 1200, a set of individuals 502 may rate the individual perspectives 506 of various content items 422, e.g., as an individual perspective rating 1202 comprising the ratio of the number of individuals 502 who express approval or appreciation of a particular content item 422 and the number of individuals 502 who express disapproval or dislike of the content item 422. An individual perspective rating threshold may be applied to avoid selecting content items 422 having a comparatively low individual perspective rating 1202, and a selection 1008 may be applied to the content items 422 presenting a comparatively high individual perspective rating 1202. These and other techniques may be utilized to select the individuals 502 and the content items 422 associated therewith in accordance with the techniques presented herein.

### 5.3. User Interface

A third aspect that may vary among embodiments of the presented techniques involves the user interface whereby a user 112 is recommended a set of content items 422 that relate to various topics 504, and through which the user 112 may select a content item 422 for presentation.

As a first variation of this third aspect, a user interface my present to the user 112 a collection of topics 504 about which at least one content item 422 is available that is associated with an individual 502 having an individual background 602 that is similar to the user background 604 of the user 112, and that presents an individual perspective 506 that is different from the user perspective 510 of the user 112 about the topic 504). Upon receiving form the user 112 a selection of a topic 504, the user interface may recommend the content items 422 that are associated with the selected topic 504; and upon receiving a selection of a recommended content item 422, the user interface may present the selected content item 422 to the user 112.

As a second variation of this third aspect, a user interface may present the content items 422 and/or topics 504 to the user 112 in the form of a visual cloud, such as a word cloud of the topics 504 represented by various content items 422. Alternatively or additionally, a user interface may select a center coordinate, and may present respective content items 422 by calculating a polar offset of the content item 422 (e.g., according to the age of the content item 422, a perspective difference score between the individual perspective 506 of the content item 422 and the user perspective 510 of the user 112, and/or the individual perspective rating 1202 of the content item 422). As one example, the polar coordinate may be calculated according to the formulae:

r=c\sqrt{n};θ=n×φ,

wherein r is the distance of the content item 422 from the center coordinate;

c is a constant defining the spatial separation of the content items 422 presented in the radial interface;

n is the age of the content item 422 (e.g., in hours or days since creation and/or publication);

### θ is the radial offset of the content item 422; and

φ is a constant such as the golden ratio (defined as approximately 1.618).

The user interface may then present the content item 422 at the polar offset with respect to the center coordinate. In a still further variation, respective topics 504 may be presented peripherally to the visual cloud of the content items 422, optionally with a Bezier curve connecting sets of content items 422 with the peripherally presented topic 504 that is associated with the content items 422. Alternatively or additionally, a visual style may be selected for the respective topics 504, and the user interface may present the content items 422 in the visual style that has been selected for the topic 504 of the content item 422. Alternatively or additionally, at the polar coordinate, the user interface may present a preview of the selected content item 422; and upon receiving from the user 112 an activation of a particular content item 422, the user interface may present the activated content item 422 to the user 112.

FIG. 13 presents an illustration of a scenario 1300 featuring an example user interface 1302 for presenting a set of content items 422 to a user 112. In this scenario 1300, the user interface 1302 is centered around a center coordinate 1304, and for various content items 422, a circle 1306 is depicted representing the content item 422. The circles 1306 are arrayed along Bezier curves that radiate outward toward a peripherally presented word cloud 1308 that indicates the topic 504 of the circles 1306 along each Bezier curve. A selection 1310 of a circle 1306 causes a presentation of the content item 422 recommended to the user 112. In this manner, the user interface 1302 may present a topically oriented arrangement of recommended content items 422 to the user 112 in accordance with the techniques presented herein.

### 6. Usage of Terms

Although the subject matter has been described in language specific to structural features and/or methodological acts, the subject matter defined in the appended claims is not necessarily limited to the specific features or acts described above. Rather, the specific features and acts described above are disclosed as example implementations of the claims.

Although the disclosed subject matter has been shown and described with respect to one or more implementations, equivalent alterations and modifications may occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application.

The claimed subject matter may be implemented in various ways, such as a method, an apparatus, or an article of manufacture. Each such implementation may utilize standard programming and/or engineering techniques to produce software, firmware, hardware, or any combination thereof to control a computer to implement the disclosed subject matter. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

As used herein and unless specified otherwise or clear from context, terms such as “and”, “or”, or “and/or,” may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense.

As used herein and unless specified otherwise or clear from context, the term “or” is intended to mean an inclusive “or” rather than an exclusive “or”.

As used herein and unless specified otherwise or clear from context, the terms “a,” “an,” or “the” may convey either a singular usage or a plural usage.

As used herein and unless specified otherwise or clear from context, the terms “first,” “second,” etc. are not intended to imply a temporal aspect, a spatial aspect, an ordering, etc. Rather, such terms are merely used as identifiers, names, etc. for features, elements, items, etc. For example, the terms “a first object” and “a second object” generally correspond to object A and object B, or two different objects, or two identical objects, or the same object.

As used herein and unless specified otherwise or clear from context, the terms “includes”, “having”, “has”, “with”, and variants thereof are used in either the detailed description or the claims, such terms are intended to be inclusive in a manner similar to the term “comprising.”

As used herein and unless specified otherwise or clear from context, the phrase “at least one of,” such as “at least one of A and B,” generally means A, or B, or both A and B.

As used herein and unless specified otherwise or clear from context, the term “example” is used herein to mean serving as an example, instance, illustration, etc., and not necessarily as advantageous. Any aspect or design described herein as “example” is not necessarily to be construed as advantageous over other aspects or designs. Rather, use of the word example is intended to present concepts in a concrete fashion.

As used herein and unless specified otherwise or clear from context, the term “based on” may be understood as not necessarily intended to convey an exclusive set of factors and may, instead, allow for existence of additional factors not necessarily expressly described, again, depending at least in part on context.

As used herein and unless specified otherwise or clear from context, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As used herein and unless specified otherwise or clear from context, the term “article of manufacture” as used herein is intended to encompass a computer program accessible from any computer-readable device, carrier, or media.

1. A method of recommending a content item to a user having a user background, comprising:
identifying a user perspective of the user about a topic;
selecting, from an individual set, an individual having an individual background that is similar to the user background of the user;
identifying a content item associated with the individual and presenting an individual perspective about the topic that differs from the user perspective of the user about the topic; and
presenting the content item to the user.

2. The method of claim 1, wherein identifying the user perspective of the user about the topic further comprises: identifying the user perspective of the user about the topic expressed in at least one message of the user.

3. The method of claim 2, wherein:
the user is a member of a user set; and
identifying the user perspective of the user expressed in the at least one message further comprises, for respective messages expressed by the members of the user set:
identifying at least one identifier in the message, and
correlating the identifier with a user perspective of the member about the topic.

4. The method of claim 1, wherein identifying the user perspective of the user further comprises:
for the respective topics associated with a user perspective of the user, ranking the topics according to a user perspective score of the user perspective about the topic; and
selecting a representative user perspective subset of the user according to the user perspective scores of the user perspectives about the topic.

5. The method of claim 4, wherein selecting the representative user perspective subset of the user further comprises: excluding, from the representative user perspective subset, an excluded user perspective having a user perspective score about the topic that is above a user perspective score threshold.

6. The method of claim 1, wherein identifying the user perspective of the user about the topic further comprises: for respective topic, inferring the user perspective of the user about the topic from the user background of the user.

7. The method of claim 6, wherein:
the user is a member of a user set, where respective members are associated with a user background; and
inferring the user perspective of the user about the topic further comprises:
clustering the members of the user set into at least one cluster according to the user background of the member; and
inferring the user perspective of the members of the cluster about the topic.

8. A nontransitory memory device storing instructions that, when executed on a processor of a server, cause the server to recommend a content item to a user having a user background, by:
identifying a user perspective of the user about a topic;
selecting, from an individual set, an individual having an individual background that is similar to the user background of the user;
identifying a content item associated with the individual and presenting an individual perspective about the topic that differs from the user perspective of the user about the topic; and
presenting the content item to the user.

9. The nontransitory memory device of claim 8, wherein selecting the individual from the individual set further comprises: selecting the individual according to a network distance of the individual and the user within the individual set.

10. The nontransitory memory device of claim 8, wherein identifying the content item further comprises:
for respective content items, calculating a perspective difference score between the individual perspective of the content item and the user perspective of the user about the topic; and
selecting a content item having a perspective difference score within a perspective difference score range.

11. The nontransitory memory device of claim 8, wherein identifying the content item further comprises: identifying a content item that has an individual perspective about the topic that differs from the user perspective of the user about the topic and that does not oppose the user perspective of the user about the topic.

12. The nontransitory memory device of claim 8, wherein:
identifying the content item further comprises: upon receiving from a first user at least one user rating of the content item, store the user rating of the content item; and
identifying the content item further comprises: identifying a content item according to the at least one user rating of the content item.

13. A server that recommends a content item to a user having a user background, the server comprising:
a processor; and
a memory storing instructions that, when executed on the processor, present:
a user perspective determiner that identifies a user perspective of the user about a topic;
a content item recommender that:
selects, from an individual set, an individual having an individual background that is similar to the user background of the user; and
identifies a content item associated with the individual presenting an individual perspective about the topic that differs from the user perspective of the user about the topic; and
a content item presenter that presents the content item to the user.

14. The server of claim 13, wherein:
the content item recommender identifies the content item by, upon receiving from the user a selection of a selected topic, identifying at least two selected content items about the selected topic, including the content item of the individual that presents an individual perspective about the selected topic that differs from the user perspective of the user about the topic; and
presenting the content item to the user further comprises: presenting the selected content items to the user in relation to the selected topic.

15. The server of claim 14, wherein:
the user is associated with a diversity score; and
the content item recommender identifies the content item by:
for the respective selected content items, calculating a perspective difference score between the individual perspective of the selected content item and the user perspective of the user about the topic; and
identifying the at least two selected content items according to the diversity score of the user and the perspective difference scores of the selected content items.

16. The server of claim 13, wherein the content item presenter presents the selected content items by:
for at least two topics, identifying at least two selected content items of the individual from an individual perspective about the selected topic that differs from the user perspective of the user about the topic;
presenting a visual cloud of the at least two selected content items.

17. The server of claim 16, wherein the content item presenter presents the visual cloud of the selected content items by:
selecting a center coordinate; and
for the respective selected content items:
calculating a polar offset according to an age of the selected content item; and
presenting the selected content item at the polar offset with respect to the center coordinate.

18. The server of claim 16, wherein the content item presenter presents the selected content items by:
presenting the at least one topic peripheral to the visual cloud of the selected content items; and
presenting a Bezier curve connecting at least one selected content item with the topic associated with the selected content item.

19. The server of claim 16, wherein the content item presenter presents the selected content items by:
for the respective topics, selecting a visual style; and
presenting the selected content item in the visual style selected for the topic of the selected content item.

20. The server of claim 16, wherein the content item presenter presents the selected content items by:
presenting, at the polar coordinate, a preview of the selected content item; and
upon receiving from the user an activation of an activated content item, present the activated content item to the user.
